(19) United States
(12) Patent Application Publication
(10) Pub. No.: US 2022/0259020 A1
(43) Pub. Date: Aug. 18, 2022

(54) CONFIGURABLE LOW-PROFILE INNER ARM ADAPTER FOR VEHICLE LIFT

(71) Applicant: Vehicle Service Group, LLC, Madison, IN (US)

(72) Inventors: Jason T. Stewart, Harvest, AL (US); Ronald Schneider, Addyston, OH (US); Christopher T. Ellington, Owenton, KY (US)

(73) Assignee: Vehicle Service Group, LLC, Madison, IN (US)

(21) Appl. No.: 17/665,995

(22) Filed: Feb. 7, 2022

Related U.S. Application Data
(60) Provisional application No. 63/148,918, filed on Feb. 12, 2021.

(51) Int. Cl. B66F 7/28

(52) U.S. Cl. CPC B66F 7/28

(57) ABSTRACT

A vehicle lift includes a vehicle carrier and a pair of arms. The vehicle carrier can selectively raise and lower a vehicle relative to the ground. Each arm in the pair of arms is pivotally coupled with the vehicle carrier. Each arm in the pair of arms includes a first arm segment, a second arm segment, and an adapter. The arm segments have a telescoping relationship. The adapter is coupled with the second arm segment and is slidable along at least part of the length of the second arm segment. The adapter is capable of coupling with an accessory at a first vertical profile and a lower vertical profile to thereby allow the accessory to contact a vehicle to allow the vehicle carrier to raise and lower the vehicle.

### PRIORITY

This application claims priority of U.S. Provisional Patent Application No. 63/148,918, entitled “Configurable Low-Profile Inner Arm Adapter for Vehicle Lift,” filed Feb. 12, 2021.

### BACKGROUND

A variety of automotive lift systems have been made and used over the years in a variety of contexts. Some types of automotive lifts are installed in-ground, while other types are installed above-ground. In some in-ground lifts, one or more posts are selectively retractable/extendable relative to the ground to raise/lower a vehicle relative to the ground. For instance, a single post may be positioned under the center of the vehicle. Alternatively, one post may be positioned at one side of the vehicle while another post is positioned at the opposite side of the vehicle. Such one or more posts may include superstructures that are capable of engaging the vehicle. Such superstructures may be mounted or otherwise coupled near the tops of the posts, such that the superstructure is raised/lowered relative to the ground as the one or more posts are retracted/extended relative to the ground. Such superstructures may include a yoke with one or more arms movably mounted thereto. For instance, a yoke may have a pair of arms that are movable relative to the yoke to selectively position the arms relative to the yoke. Each arm may have a member that is configured to engage the vehicle.

Examples of automotive lifts and associated components are disclosed in U.S. Pat. No. 5,740,886, entitled “Method of Retrofit of In-Ground Automotive Lift System,” issued Apr. 21, 1998, the disclosure of which is incorporated by reference herein; U.S. Pat. No. 6,571,919, entitled “Removable Cylinder Arrangement for Lift,” issued Jun. 3, 2003, the disclosure of which is incorporated by reference herein; U.S. Pat. No. 6,814,187, entitled “System for Detecting Liquid in an Inground Lift,” issued Nov. 9, 2004, the disclosure of which is incorporated by reference herein; and U.S. Pat. No. 8,973,712, entitled “Inground Superstructure and Integrated Third Stage Arm for Vehicle Lift,” issued Mar. 10, 2015, the disclosure of which is incorporated by reference herein.

While a variety of automotive lift systems have been made and used, it is believed that no one prior to the inventors has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 shows a perspective view of an exemplary vehicle lift system with its posts retracted relative to the ground;

FIG. 2 shows a perspective view of the vehicle lift system of FIG. 1 with its posts extended relative to the ground and with a housing of the vehicle lift system omitted for purposes of clarity;

FIG. 3A shows a perspective view of an arm assembly and a respective adjustable adapter of the vehicle lift system of FIG. 1, where the arm assembly is in an extended position;

FIG. 3B shows a perspective view of the arm assembly and the respective adjustable adapter of FIG. 3A, where the arm assembly is in a retracted position;

FIG. 4 shows an enlarged perspective view of a distal portion of the arm assembly and the respective adjustable adapter of FIG. 3A;

FIG. 5 shows an exploded perspective view of the distal portion of the arm assembly and the respective adjustable adapter of FIG. 3A;

FIG. 6 shows a cross-sectional view of the distal portion of the arm assembly and the respective adjustable adapter of FIG. 3A, taken along the centerline thereof;

FIG. 7 shows an exploded perspective view of the adjustable adapter of FIG. 3A;

FIG. 8A shows a perspective view of the distal portion of the arm assembly and the respective adjustable adapter of FIG. 3A, where the adjustable adapter is in a retracted position relative to a second segment of the arm assembly;

FIG. 8B shows a perspective view of the distal portion of the arm assembly and the respective adjustable adapter of FIG. 3A, where the adjustable adapter is in an extended position relative to the second segment of the arm assembly;

FIG. 8C shows a perspective view of the distal portion of the arm assembly and the respective adjustable adapter of FIG. 3A, where the adjustable adapter is in a reversed extended position relative to the second segment of the arm assembly;

FIG. 9A shows a perspective view of the distal portion of the arm assembly and the respective adjustable adapter of FIG. 3A, where the adjustable adapter is in the retracted position relative to a second segment of the arm assembly, where a vehicle engagement pad is coupled to a first profile section of the adjustable adapter;

FIG. 9B shows a perspective view of the distal portion of the arm assembly and the respective adjustable adapter of FIG. 3A, where the adjustable adapter is in the extended position relative to the second segment of the arm assembly, where the vehicle engagement pad of FIG. 9A is coupled to a low-profile section of the adjustable adapter;

FIG. 9C shows a perspective view of the distal portion of the arm assembly and the respective adjustable adapter of FIG. 3A, where the adjustable adapter is in the reversed extended position relative to the second segment of the arm assembly, where the vehicle engagement pad of FIG. 9A is coupled to the first profile section of the adjustable adapter; and

FIG. 10 shows a cross-sectional view of the distal portion of the arm assembly and the respective adjustable adapter of FIG. 3A, taken along the centerline thereof, where a vehicle engagement pad is coupled to both the first profile section and the low-profile section of the adjustable adapter to highlight a height difference between the first profile section and the low-profile section.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

I. Overview of Exemplary Lift

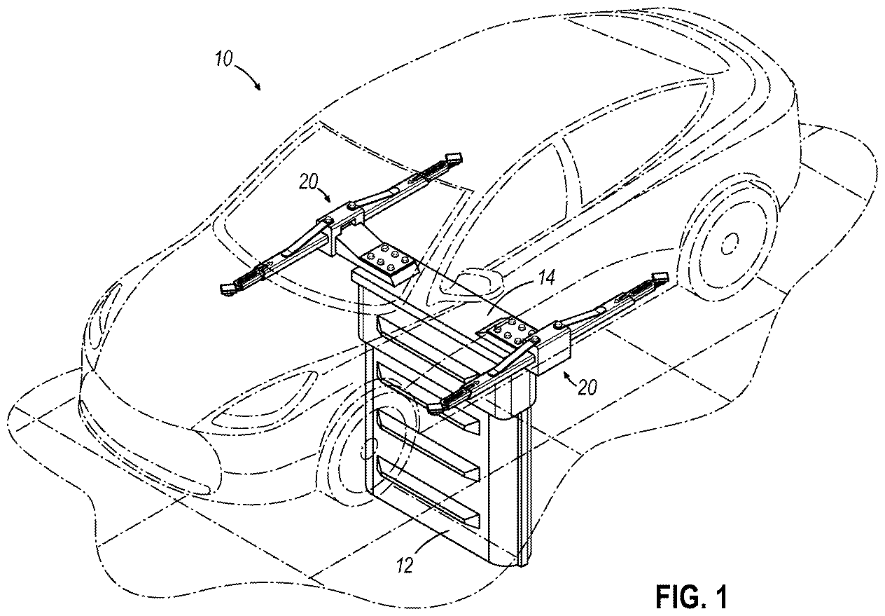

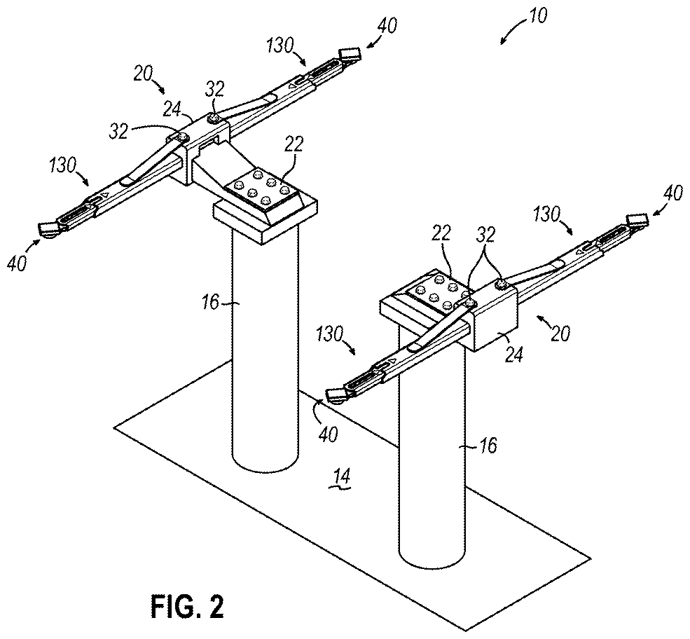

FIGS. 1-2 illustrate an exemplary lift (10). Lift (10) of the present example comprises a housing (12) that extends beneath the level of ground (e.g., shop floor, etc.), a base plate (14) that is fixedly positioned relative to ground (e.g., level with shop floor, slightly elevated relative to shop floor, etc.), and a pair of posts (16) that extend or retract relative to the level of ground. For instance, FIG. 1 shows posts (16) retracted into the ground while FIG. 2 shows posts (16) extended relative to the ground. A superstructure (20) is fixedly mounted to the top of each post (16). Each superstructure (20) comprises a base portion (22), which is bolted or otherwise secured to the top of each post (16), and a yoke portion (24), which is integral with base portion (22). Each yoke portion (24) is associated with a respective pair of arm assemblies (130), which are pivotally secured to their corresponding yoke portion (24). In particular, each arm assembly (130) is joined to its corresponding yoke portion (24) by a pin (32). Each arm assembly (130) is rotatable about the longitudinal axis defined by its corresponding pin (32). While in the current example, superstructure (20) is used, any other suitable superstructure may be used as would be apparent to one skilled in the art in view of the teachings herein.

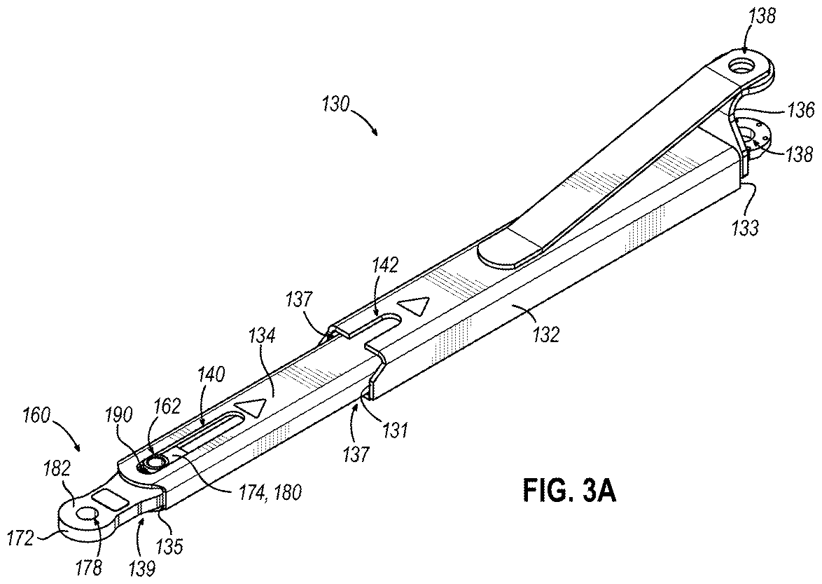

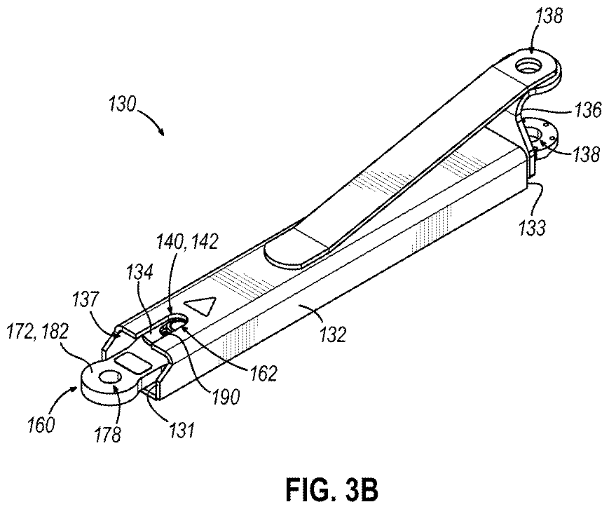

As will be described in greater detail below, arm assemblies (130) are configured to selectively attach to a respective vehicle engagement pad (40) via an adjustable adapter (160) (see FIGS. 3A-3B). Arm assemblies (130) and respective vehicle engagement pads (40) are configured to engage a vehicle and may be selectively positioned to engage a particular vehicle at particular lift points associated with the particular vehicle. For instance, with posts (16) retracted in the ground, arm assemblies (130) may be initially positioned outward as shown in FIG. 1. The vehicle may then drive to a position over base plate (14) (e.g., such that the length of the vehicle is substantially centered over base plate (14)). The vehicle may need to drive over base portions (22) of superstructures (20) at this stage. For instance, the vehicle's wheels may ride directly over base portions (22). With the vehicle suitably positioned relative to lift (10), arm assemblies (130) may be rotated inwardly about pins (32) and suitably extend/retract in order to suitably align vehicle engagement pads (40) with lift point positions underneath the vehicle.

With arm assemblies (130) and pads (40) at appropriate positions, posts (16) may be extended relative to the ground. With vehicle engagement pads (40) being engaged with the vehicle at the selected lift points, and with arm assemblies (130) being engaged with pads (40) via adjustable adapter (160) (see FIGS. 3A-3B) and posts (16) via superstructures (20), such extension of posts (16) will raise the vehicle relative to the ground.

II. Exemplary Arm Assembly

FIG. 3A shows arm assembly (130) of the present example. Arm assembly (130) comprises a first segment (132) and a second segment (134). First segment (132) has an open distal end (131) and a proximal end (133). Second segment (134) has an open distal end (135) and a proximal end (not shown). In the current example, first segment (132) and second segment (134) are elongated hollow metallic bodies. However, it should be understood that segments (132, 134) may take the form of any suitable material and any suitable shape as would be apparent to one skilled in the art in view of the teachings herein.

First segment (132) of the present example includes a mounting portion (136). Mounting portion (136) provides a coupling with superstructure (20). Mounting portion (136) includes a pair of aligned openings (138), which are configured to receive pin (32) to provide pivoting coupling of a respective arm assembly (130) with superstructure (20).

Second segment (134) telescopically extends from first segment (132) such that the effective length of arm assembly (130) may be selectively varied. In particular, first segment (132) defines a hollow interior (137) that is configured to receive second segment (134) such that second segment (134) may extend and retract relative to first segment (132) between an extended position (as shown in FIG. 3A) and a retracted position (as shown in FIG. 3B).

Second segment (134) defines a hollow interior (139) in communication with open distal end (135). As will be described in greater detail below, hollow interior (139) is dimensioned to slidably receive adjustable adapter (160).

Second segment (134) of arm assembly (130) further defines a slot (140). First segment (132) also defines a slot (142) that extends proximally from open distal end (131). Slot (142) is substantially aligned with slot (140). In particular, slots (140, 142) are suitably aligned such that when second segment (134) is adjusted toward the retracted position (as shown in FIG. 3B), slot (142) may house a vehicle pad receptacle (162) such that vehicle pad (40) may be attached to vehicle pad receptable (162) in accordance with the description herein while receptable (162) is housed in slot (142) (as shown in FIG. 3B).

Arm assembly (130) may further be configured such that the longitudinal position of second segment (134) relative to first segment (132) may be selectively locked once second segment (134) has been translated relative to first segment (132) to a desired longitudinal position. Various suitable ways in which such selective locking may be provided will be apparent to those of ordinary skill in the art in view of the teachings herein. In some versions, a locking mechanism or feature is omitted. For instance, in some versions, friction may substantially maintain an adjusted longitudinal positioning of second segment (134) relative to first segment (132). In other words, the mass and/or other properties of segments (132, 134) may permit a user to slide second segment (134) relative to first segment (132) to achieve an adjusted positioning; allow the user to then release second segment (134); and keep second segment (134) substantially in the adjusted position until the user again manipulates second segment (134) for further adjustment.

III. Exemplary Adjustable Adapter Configured to Couple Vehicle Pad and Arm Assembly at Multiple Profile Heights

As mentioned above, once a vehicle is initially driven over lift (10), arm assemblies (130) and vehicle engagement pads (40) may be pivoted about pins (32) until positioned under the vehicle. As also mentioned above, once arm assemblies (130) and vehicle engagement pads (40) are suitably under a vehicle, the length of arm assemblies (130) and the longitudinal position of engagement pad (40) relative to arm assemblies (130) may be adjusted in accordance with the description herein in order to suitably align vehicle engagement pads (40) with lift point positions of the vehicle.

However, in some instances, arm assemblies (130) and respective vehicle engagement pads (40) may not be able to suitably access the vehicle lift point positions. For example, while coupled with arm assembly (130), the vertical height of vehicle engagement pad (40) may extend above the maximum vertical height available for arm assembly (130) and vehicle engagement pad (40) to access the underside of a vehicle already resting on the ground. In such instances, if an operator attempted to rotate arm assembly (130) and pad (40) under the vehicle to access vehicle lift points, pad (40) may undesirably collide with the body of the vehicle.

Previously, a “low-profile” extension plate would be welded to the distal end of an arm assembly (130) such that the extension plate extended distally past open distal end (135). A “low-profile” extension plate would be able to couple with and support a vehicle engagement pad (40) at a lower vertical height compared to inserting pad (40) through slot (140) of second segment (134). Therefore, while a “low-profile” extension plate may provide access to a vehicle having a lower vertical profile, the extension plate was not adjustable relative to second segment (134).

Since this “low-profile” extension plate would permanently extend distally from open distal end (135) of second segment (142), the extension plate may act as an obstruction when either (A) second segment (134) needs to be closer to the fully retracted position (as shown in FIG. 3B) or (B) pad (40) is coupled with second segment (134) via slot (140). For example, when lifting an all-electric vehicle (EV) while vehicle engagement pad (40) is coupled to second segment (134) via slots (140), a permanent “low-profile” extension plate may prevent an operator from suitably accessing the battery components of an EV while lifted. For instance, the permanent “low-profile” extension plate may block the battery cover plate from being removed while an EV is lifted or even block batteries from being removed from a lifted vehicle altogether.

Therefore, it may be desirable to provide an arm adapter that allows an operator to couple vehicle engagement pad (40) via slot (140) or couple with a “low-profile” section that is distal relative to open distal end (135) of second segment (134), while also providing an adjustable capability such that the “low-profile” section may be entirely restricted within second segment (134) if needed.

FIGS. 3A-10 show an exemplary adjustable adapter (160) that is configured to (A) adjustably couple with second segment (134) and (B) couple with a vehicle engagement pad (40) in a first profile configuration and a second, low-profile configuration. It should be understood that the first profile configuration and the low-profile configuration elevate engagement pad (40) to different vertical heights, thereby allowing pad (40) to access the underside of a variety of vehicles.

As will be described in greater detail below, adjustable adapter (160) is configured to translate relative to second segment (134) of arm assembly (130) such that the portion of adjustable adapter (160) forming the low-profile section may be entirely housed within second segment (134) if needed, while the portion of adjustable adapter (160) forming the low-profile section may also extend distally from open distal end (135) of second segment (134) if needed.

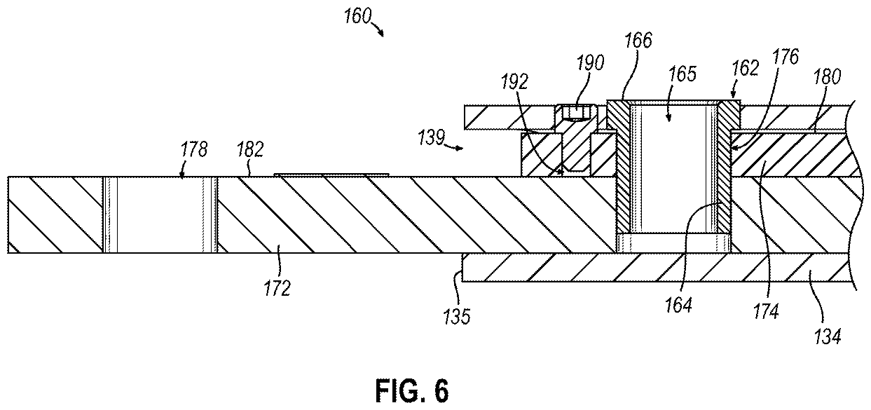

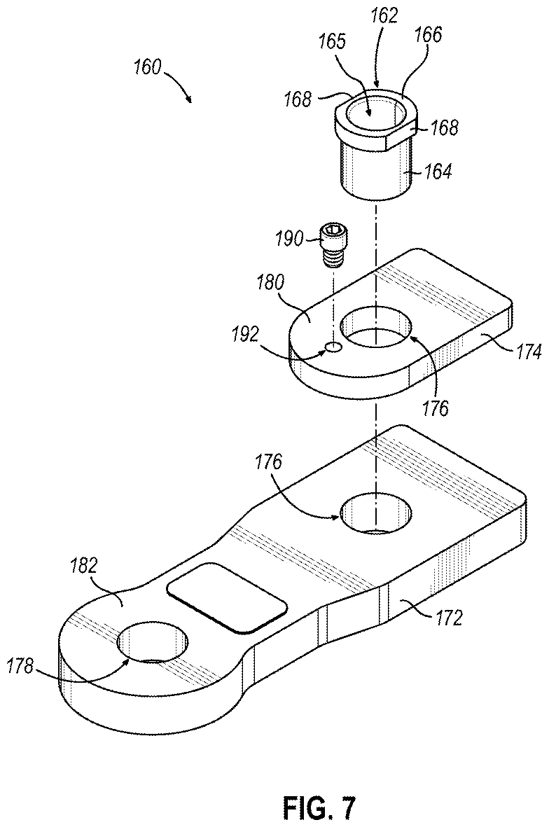

As best shown in FIGS. 6-7, adjustable adapter (160) includes a vehicle pad receptacle (162), a first body (172) having a low-profile platform (182), a second body (174) having a first profile platform (180), and a removable adapter containment member, such as containment screw (190).

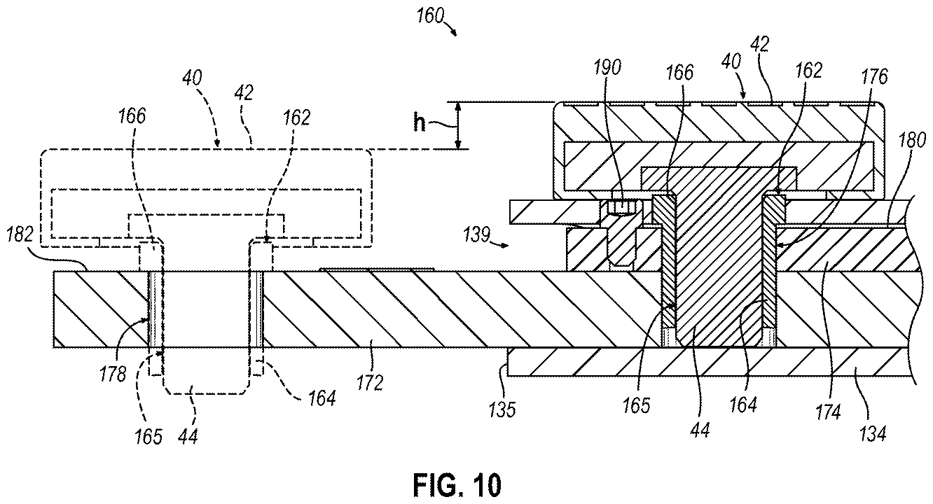

Vehicle pad receptacle (162) includes a sheath (164) and a collar (166) having a pair of flats (168). Vehicle pad receptacle (162) defines a hollow opening (165) extending from collar (166) through sheath (164). As best shown in FIG. 10, hollow opening (165) is dimensioned to selectively receive a post (44) of vehicle engagement pad (40) such that an engagement platform (42) of pad (40) rests above collar (166). Therefore, an operator may easily insert and remove post (44) into and out of hollow opening (165) of receptacle (162). As will be described in greater detail below, vehicle pad receptable (162) is dimensioned to be moved relative to the rest of adjustable adapter (160) to rest on the either the first profile platform (180) or the low-profile platform (182), depending on which height profile an operator wishes to support pad (40). Therefore, adjustable adapter (160) is configured to easily couple with and support pad (40) in either the first profile platform (180) or the low-profile platform (182).

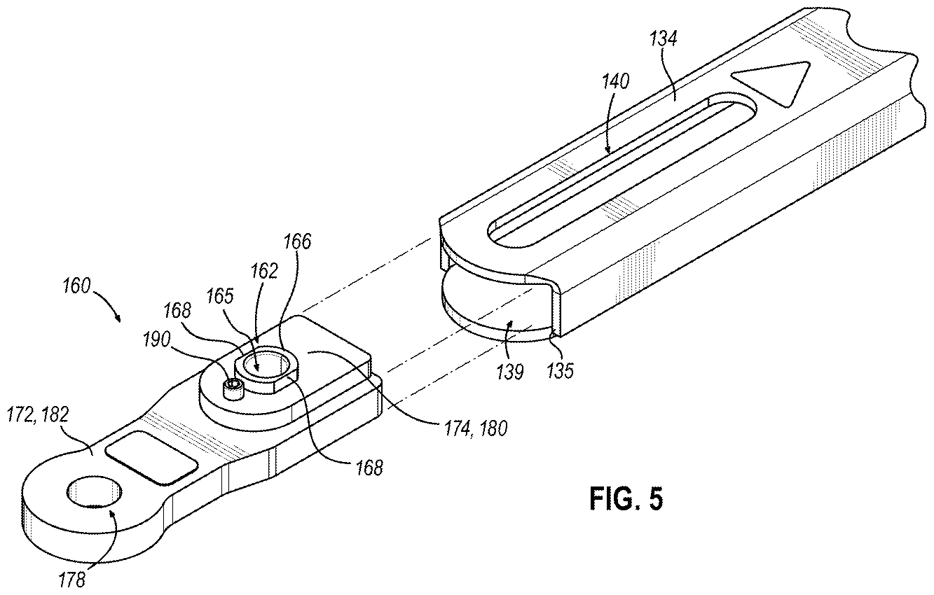

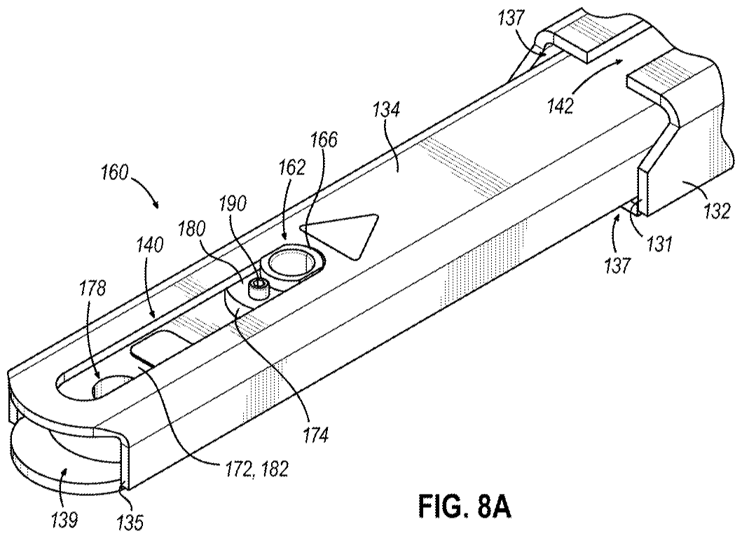

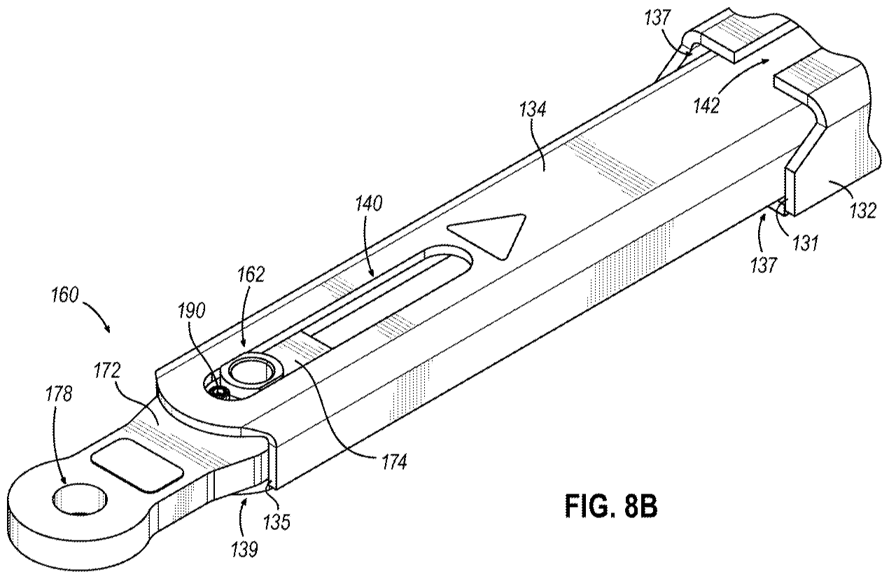

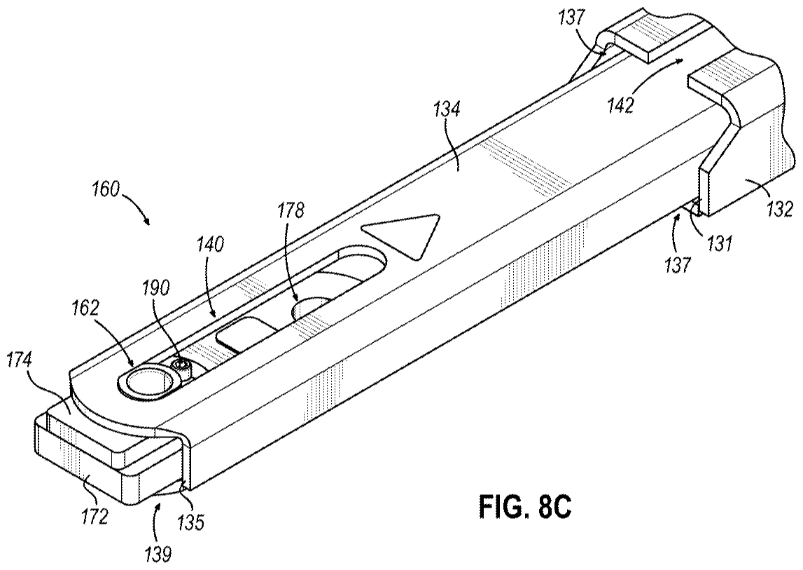

First body (172) and second body (174) are suitably coupled with each other. First body (172) and second body (174) are dimensioned to slidably fit within hollow interior (139) of second segment (134) such that platforms (180, 182) face upward toward slot (140). In particular, first body (172) and second body (174) are configured to be inserted into second segment (134) at open distal end (135). First body (172) and second body (174) may be inserted into open distal end (135) in the orientation shown in FIG. 5. Alternatively, first body (172) and second body (174) may be inserted into open distal end (135) in reverse fashion, as shown in FIG. 8C.

First body (172) has a first thickness, while second body (174) has a second thickness. As best shown in FIG. 6, first body (172) and second body (174) are stacked on top of each other such that first profile collar platform (180) is raised relative to low-profile collar platform (182). As best shown in FIG. 10, the difference in height between first profile collar platform (180) and low-profile collar platform (182) contributes to difference in height (h) when vehicle engagement pad (40) is attached to adapter (160) via a first profile through hole (176) and a second profile through hole (178), which are described in greater detail below.

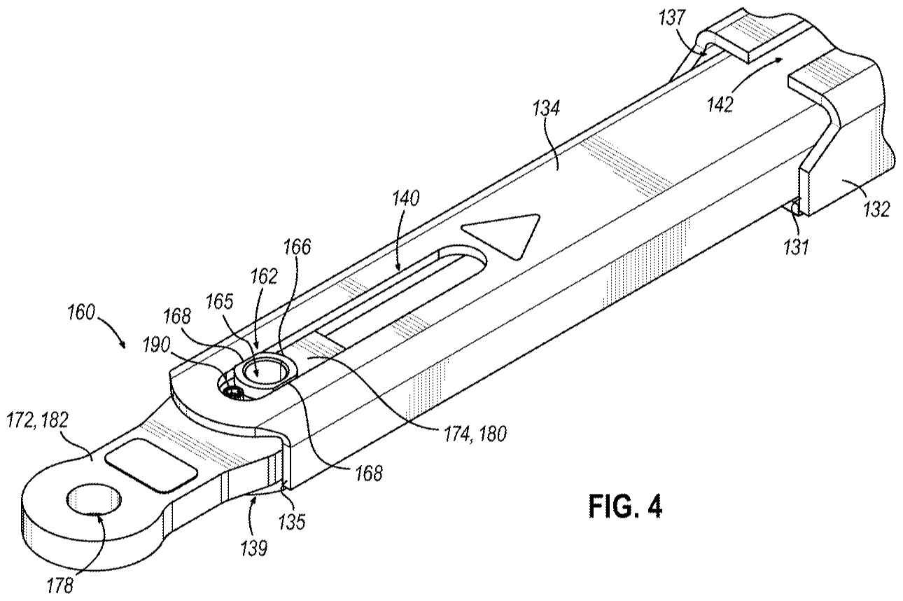

First body (172) and second body (174) each define a portion of a first profile through hole (176). First body (172) and second body (174) are attached to each other such that respective portions of first profile through hole (176) are suitably aligned. When first body (172) and second body (174) are slidably received within second segment (134), through hole (176) is aligned with slot (140) such that sheath (164) of receptacle (162) may be inserted through slot (140) and into first profile through hole (176). In such instances, as shown in FIGS. 4, 8A, and 8C, flats (168) of collar (166) are directly adjacent to the sidewalls of slot (140), thereby substantially rotationally fixing receptacle (162) about its own long axis.

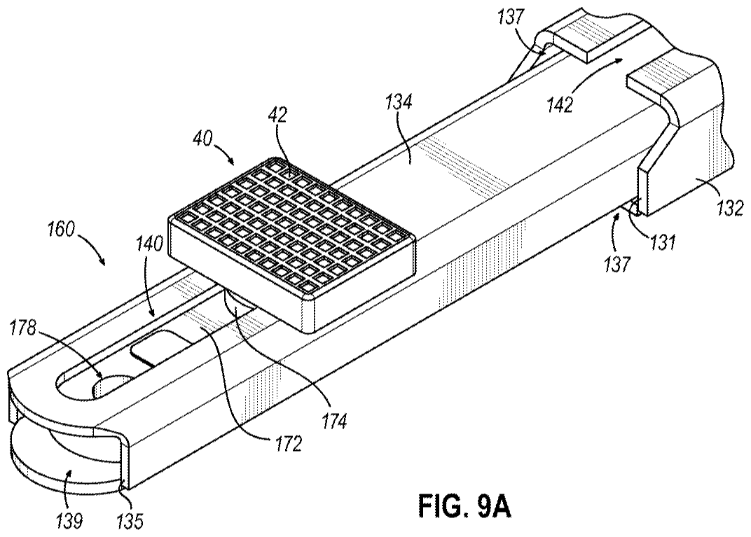

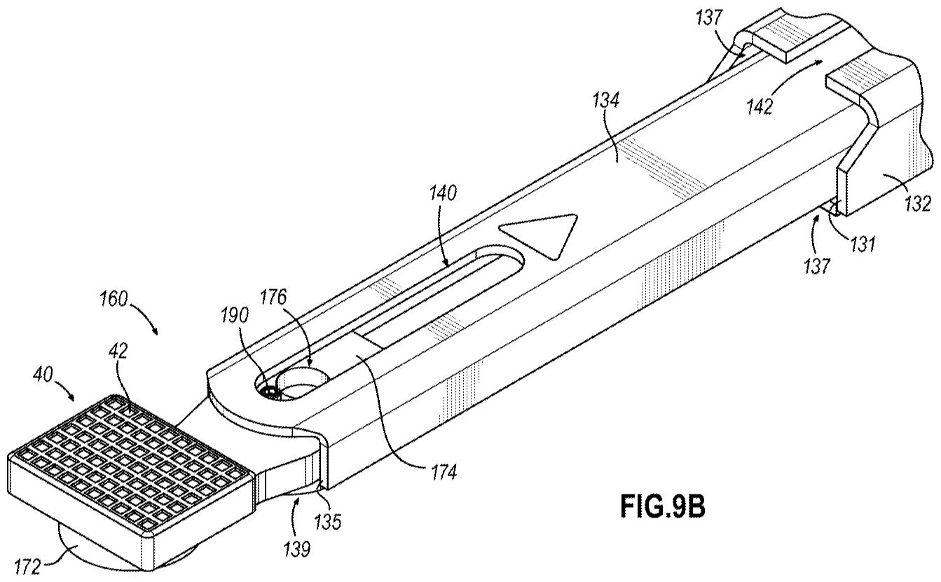

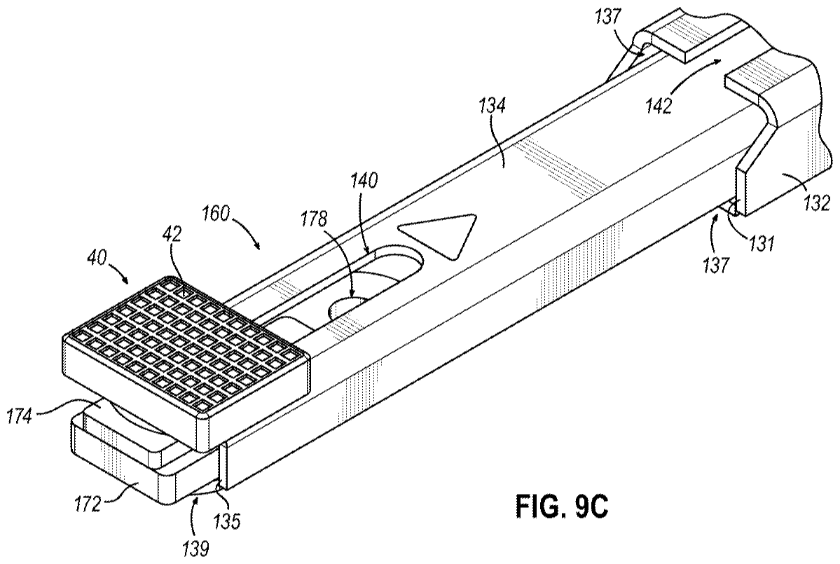

A portion of first body (172) also extends away from second body (174) while defining a low-profile through hole (178). As best shown in FIG. 10, low-profile through hole (178) is configured to selectively receive sheath (164) of vehicle pad receptacle (162) to thereby couple to a pad (40) at a low-profile height. When first body (172) and second body (174) are slidably received within second segment (134), the portion of first body (172) defining low-profile through hole (180) may be extended distally past open distal end (135) of second segment such that sheath (164) of receptable (162) may be inserted into low-profile through hole (180). Therefore, an operator may adjust the longitudinal position of adapter (160) to couple with vehicle engagement pad (40) at either a first profile mode (as shown in FIGS. 9A and 9C) or a low-profile mode (as shown in FIG. 9B).

Each platform (180, 182) is configured to support the underside of collar (166) when receptacle (162) is suitably inserted through the respective through hole (176, 178). First body (172) and second body (174) may be attached to each other through any suitable means as would be apparent to one skilled in the art in view of the teachings herein. For example, first body (172) and second body (174) may be welded together. In some instances, first body (172) and second body (174) may be integral pieces such that first profile collar platform (180) and second profile collar platform (182) are formed from a single piece of material (either through traditional manufacturing means, or through an additive manufacturing process such as 3D printing).

Additionally, second body (174) also defines a threaded opening (192) dimensioned to suitably couple with containment screw (190). Containment screw (190) may be inserted through slot (140) to selectively attach to second body (174) while adapter (160) is slidably contained within hollow interior (139) of second segment (134) to thereby prevent adapter (160) from accidentally sliding out of second segment (134). When suitably coupled, containment screw (190) extends above first profile collar platform (180) within slot (140) such that adapter (160) is restricted from actuating too far distal or proximal within second segment via contact between slot (140) and containment screw (190). Additionally, containment screw (190) may also be removed from threaded opening (192) to allow adapter (160) to be selectively removed from hollow interior (139) of second segment (134). While in the current example containment screw (190) coupled with second body (174) in a threaded manner, containment screw (190) may couple with second body (174) through any suitable means as would be apparent to one skilled in the art in view of the teachings herein. For example, containment screw (190) may be a pin easily dropped into a pin opening defined by second body (174).

When an operator desires to couple a vehicle engagement pad (40) with adapter (160) at a first profile height, the operator may insert receptacle (162) into first through hole (176) via slot (140) while first body (172) and second body (174) are slidably coupled with second segment (134), as shown in FIG. 8A. Once receptacle (162) is suitably coupled with first body (172) and second body (174), the operator may insert post (44) of vehicle engagement pad (40) within receptacle (162) such that engagement portion (42) of pad (40) rests on top of collar (166), as shown in FIG. 9A. If the operator desires to further adjust the longitudinal location of pad (40) relative to second segment (134), the operator may actuate pad (40) and adapter (160) relative to second segment (134) together.

If the operator wishes to actuate pad (40) at the first profile height distally within slot (140) to such a degree that a portion of first body (172) extends distally past open distal end (135) (as shown in FIG. 8B), but the operator does not wish to have first body (172) protrude distally from open distal end (135), the operator may simply recouple adapter (160) as follows. The operator may detach adapter (160) from second segment (134) in accordance with the description herein, insert adapter (160) into open distal end (135) in reverse order, further couple adapter (160) with second segment (134) in accordance with the description herein (as shown in FIG. 8C), and then insert post (44) of vehicle engagement pad (40) within receptacle (162) such that engagement portion (42) of pad (40) rests on top of collar (166) (as shown in FIG. 9C).

When an operator desires to couple a vehicle engagement pad (40) with adapter (16) as a low-profile height, the operator may extend adapter to the position shown in FIG. 8B. It should be understood that since containment screw (190) is coupled to second body (174), containment screw (190) may prevent an operator from accidentally actuating adaptor (160) too far distally relative to second segment (134). Next, the operator may take receptacle (162) out of first profile through hole (176) and insert sleeve (164) of receptacle (162) into low-profile through hole (178) (as shown in FIG. 10). With receptacle (162) inserted into low-profile through hole (178), next the operator may insert post (44) of vehicle engagement pad (40) within receptacle (162) such that engagement portion (42) of pad (40) rests on top of collar (166), as shown in FIG. 9B.

As mentioned above, and as highlighted in FIG. 10, pad (40) has a lower profile while inserted through low-profile through hole (178) as compared to being inserted through first profile through hole (176). Therefore, pad (40) may be able to access the underside of vehicles with a smaller maximum vertical height required for arm assembly (130) and vehicle engagement pad (40) to access the underside of a vehicle already resting on the ground.

It should be understood that the operator may couple vehicle engagement pad (40) with adapter (160) at the first profile height while the portion of first body (172) including low-profile collar platform (182) is confined within the second segment (134). Therefore, adapter (160) may maintain the operability to couple with pad (40) in a low-profile configuration, while also maintaining the ability to couple with pad (40) in the first configuration without having any additional obstructions.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

I/We claim:

1. A vehicle lift, comprising:
(a) a vehicle carrier operable to selectively raise and lower relative to the ground, respectively, to selectively raise and lower a vehicle relative to the ground; and
(b) a pair of arms pivotally coupled with the vehicle carrier, wherein each arm of the pair of arms comprises:
(i) a first arm segment pivotally coupled with the vehicle carrier;
(ii) a second arm segment slidably disposed relative to the first arm segment, wherein the first and second arm segments are in telescoping relationship with each other; and
(iii) an adapter coupled with the second arm segment, wherein the adapter is slidable along at least part of the length of the second arm segment, wherein the adapter is configured to couple with a vehicle engagement pad, alternatively at a first vertical profile and a low vertical profile, in either profile to thereby allow the vehicle engagement pad to contact a vehicle to allow the vehicle carrier to raise and lower the vehicle.

2. The vehicle lift of claim 1, wherein the second arm defines a hollow area, and wherein the adapter is slidably housed within the hollow area.

3. The vehicle lift of claim 1, wherein the adapter comprises a low-profile platform extending away from a first vertical profile platform, wherein the low-profile platform and the first vertical profile platform are vertically spaced away from each other by a distance.

4. The vehicle lift of claim 3, wherein the low-profile platform defines a low-profile hole configured to receive the vehicle engagement pad.

5. The vehicle lift of claim 4, wherein the first vertical profile platform defines a first vertical profile hole configured to receive the vehicle engagement pad.

6. The vehicle lift of claim 5, wherein the adapter comprises a receptacle configured to fit in either the low-profile hole or the first vertical profile hole.

7. The vehicle lift of claim 1, wherein the vehicle engagement pad comprises an engagement platform.

8. The vehicle lift of claim 7, wherein the vehicle engagement pad comprises a post configured to couple with the adapter.

9. The vehicle lift of claim 1, wherein the adapter is removably coupled with the second arm segment.

10. The vehicle lift of claim 1, wherein the vehicle carrier is installed in-ground.

11. The vehicle lift of claim 1, wherein the adapter is configured to optionally be positioned so that it does not extend distally past the second arm segment.

12. The vehicle lift of claim 1, wherein the second arm segment is configured to optionally be positioned so that it does not extend distally past the first arm segment.

13. The vehicle lift of claim 1, wherein the adapter comprises an adapter containment member configured to limit sliding of the adapter to a defined range relative to the second arm segment.

14. The vehicle lift of claim 13, wherein the adapter containment member is configured to be disengaged from the second arm segment to allow for removal of the adapter from the second arm segment.

15. The vehicle lift of claim 1, wherein the adapter comprises a first body and a second body, wherein the first body comprises a low-profile platform, wherein the second body comprises a first profile platform.

16. A vehicle lift, comprising:
(a) a vehicle carrier operable to selectively raise and lower relative to the ground, respectively, to selectively raise and lower a vehicle relative to the ground; and
(b) at least one pair of arms coupled with the vehicle carrier, wherein each arm of each pair of arms comprises:
(i) first arm segment coupled with the vehicle carrier;
(ii) a second arm segment slidably disposed relative to the first arm segment, wherein the first and second arm segments are in telescoping relationship with each other; and
(iii) a removable adapter configured to selectively couple and decouple with the second arm segment, wherein the adapter is slidable along at least part of the length of the second arm segment, wherein the adapter, while selectively coupled with the second arm, is configured to couple with a vehicle engagement pad at a low vertical profile, to thereby allow the vehicle engagement pad to contact a vehicle to allow the vehicle carrier to raise and lower the vehicle.

17. The vehicle lift of claim 16, wherein the second arm defines a hollow area, and wherein the adapter is slidably housed within the hollow area.

18. The vehicle lift of claim 16, wherein the adapter is configured to be positioned so that it does not extend distally past the second arm segment.

19. A method of operating a vehicle lift to lift a vehicle having a body, wherein the vehicle lift comprises a vehicle carrier, a first arm segment pivotally coupled with the vehicle carrier, a second arm segment slidably disposed relative to the first arm segment, and an adapter coupled with the second arm segment, wherein the vehicle carrier is operable to selectively raise and lower relative to the ground, respectively, to selectively raise and lower a vehicle relative to the ground, wherein the first and second arm segments are in telescoping relationship with each other, wherein the adapter is slidable along at least part of the length of the second arm segment, and wherein the adapter is configured to couple with a vehicle engagement pad, alternatively at a first vertical profile and a low vertical profile, in either profile to thereby allow the vehicle engagement pad to contact a vehicle to allow the vehicle carrier to raise and lower the vehicle, the method comprising the steps of:
(a) determining that the second arm segment, when coupled with the vehicle engagement pad at the first vertical profile, will be incapable of lifting the vehicle without a portion of the vehicle lift coming in contact with the vehicle's body;
(b) adjusting the adapter relative to the second arm segment to allow for lifting the vehicle without a portion of the vehicle lift coming in contact with the vehicle's body;
(c) coupling the adapter to the vehicle engagement pad at the low vertical profile; and
(d) finally, lifting the vehicle using the vehicle lift.

20. The method of claim 19, further comprising a step of reconfiguring the vehicle engagement pad from the first vertical profile to the low vertical profile.
